(19) United States
(12) Patent Application Publication
(10) Pub. No.: US 2007/0268637 A1
(43) Pub. Date: Nov. 22, 2007

(54) Active matrix device

(75) Inventors: Yu-Chen Hsu, Hsinchu (TW); Chuan-Feng Liu, Hsinchu (TW); Chia-Hao Kuo, Hsinchu (TW)

Correspondence Address: SHEEHAN PHINNEY BASS & GREEN, PA;c/o PETER NIEVES, 1000 ELM STREET, MANCHESTER, NH, 03105-3701, US

(73) Assignee: Prime View International Co., Ltd.

(21) Appl. No.: 11/436,421

(22) Filed: May 18, 2006

(51) Int. Cl. H02H 9/00

(52) U.S. Cl. 361/56

(57) ABSTRACT

An active matrix device including an active region and an ESD protection circuit is provided. The active region includes scan lines and data lines. The ESD protection circuit includes a first power line, a second power line, a first diode and a second diode. The first diode is electrically connected between the scan line/data line and the first power line, and the second diode is electrically connected between the second power line and the scan line/data line. When a positive or negative ESD voltage is applied to the scan lines or the data lines, the ESD current is conducted to the first power line or the second power line through the first diodes or the second diodes, so as to protect the devices and circuits of the active matrix device from being damaged by the ESD zap.

### BACKGROUND OF THE INVENTION

1. Field of the Invention

The present invention generally relates to an active matrix device, and more particularly, to an active matrix device having an electrostatic discharge (ESD) protection design.

2. Description of Related Art

Electrostatic discharge is a phenomenon that occurs when static charges move on a non-conducting surface. The sudden movement of electric charges inside the semiconductor material of an integrated circuit (IC) package often leads to circuit failure. For example, people walking across a carpet may pick up static charges. If the relative humidity (RH) of the surrounding air is high, the human body may build up static charges that range up to thousands volts. However, if the RH of the surrounding air is low, the human body may build up static charges up to tens of thousands or more volts.

Generally, during the fabrication process of an active matrix device, such as a liquid crystal display (LCD), an organic light-emitting diode (OLED) display, an E-paper display, or a sensor such as a photo sensor or a X-ray sensor, the process equipment thereof or the operator in charge of the process equipment may accumulate and generate static charges ranged from hundreds to thousands volts of static electricity. As the aforementioned charged bodies (human, machine or equipment) come in contact with the display device or sensor, the sudden power surge due to the sudden movement of the static charges passing through the active matrix device may damage the thin film transistors and internal circuits of the active matrix device, or cause malfunctions thereof.

To minimize the damage caused by the electrostatic discharge on the thin film transistors or internal circuits of the active matrix device, a special ESD protection scheme has been developed. Referring to FIG. 1, FIG. 1 is a schematic diagram showing a conventional ESD protection circuit of an active matrix device. Such as shown in FIG. 1, an ESD protection circuit comprises an ESD ring 110, a plurality of first ESD protection units 120 and a plurality of second ESD protection units 130. Each of the first ESD protection units 120 comprises a first diode 122 and a second diode 124. A positive terminal of the first diode 122 is coupled to a scan line SL of the active matrix device, and a negative terminal of the first diode 122 is coupled to the ESD ring 110. A positive terminal of the second diode 124 is coupled to the ESD ring 110, and a negative terminal of the second diode 124 is coupled to the scan line SL. Similarly, each of the second ESD protection units 130 comprises a third diode 132 and a fourth diode 134. A positive terminal of the third diode 132 is coupled to a data line DL of the active matrix device, and a negative terminal of the third diode 132 is coupled to the ESD ring 110. A positive terminal of the fourth diode 134 is coupled to the ESD ring 110, and a negative terminal of the fourth diode 134 is coupled to the data line DL.

During an electrostatic discharge, electrostatic charges are conducted to the grounded ESD ring 110 via the first ESD protection units 120 and/or the second ESD protection units 130, and thus possible damage to the components and internal circuits of the active matrix device is prevented.

In a general operation mode, a forward bias is induced from the data lines DL to the scan lines SL, and a leakage current exists between the data lines DL and the scan lines SL through the first and second ESD protection units, thus causing the waste of extra power. Besides, if this type of ESD protection circuit is applied to a sensor, some interference would also be caused.

### SUMMARY OF THE INVENTION

Accordingly, the present invention is directed to an active matrix device having an ESD protection circuit, so as to protect devices and circuits of the active matrix device from being damaged by an ESD.

As embodied and broadly described herein, an active matrix device comprising an active region and an ESD protection circuit is provided. The active region comprises a plurality of scan lines and a plurality of data lines. The ESD protection circuit comprises a first power line, a second power line, at least one first diode and at least one second diode. A first voltage V1 is applied to the first power line and a second voltage V2 is applied to the second power line, wherein the first voltage V1 is not equal to the second voltage V2. The first diode has a positive terminal and a negative terminal, wherein the positive terminal of the first diode is electrically connected to the scan line or the data line, and the negative terminal of the first diode is electrically connected to the first power line. The second diode also has a positive terminal and a negative terminal, wherein the positive terminal of the second diode is electrically connected to the second power line, and the negative terminal of the second diode is electrically connected to the scan line or the data line.

According to a preferred embodiment of the present invention, a positive voltage is applied to the first power line, and a negative voltage is applied to the second power line.

According to another preferred embodiment of the present invention, the active matrix device further comprises a third diode, wherein a positive terminal of the third diode is electrically connected to the first power line, and a negative terminal of the third diode is electrically connected to the second power line. A bias current flows through the third diode between the first power line and the second power line.

According to another preferred embodiment of the present invention, the first power line comprises a ring type wire, and the negative terminal of the first diode is electrically connected to the ring type wire.

According to another embodiment of the present invention, the first power line comprises a plurality of discrete wires, and the first voltage VI is applied to each of the discrete wires, and a portion of the negative terminals of the first diodes are electrically connected to one of the discrete wires.

According to another embodiment of the present invention, the second power line comprises a ring type wire, and the positive terminal of the second diode is electrically connected to the ring type wire.

According to another embodiment of the present invention, the second power line comprises a plurality of discrete wires, and the second voltage V2 is applied to each discrete wire, and a portion of the positive terminals of the second diodes are electrically connected to one of the discrete wires.

According to another preferred embodiment of the present invention, a third voltage V3 is applied to the scan lines and a fourth voltage V4 is applied to the data lines, wherein different voltages are applied to the scan lines SL, the data lines DL, the first power line and the second power line respectively, and satisfy the following

formula: V1≧V4>V3≧V2.

As embodied and broadly described herein, the present invention also provides an active matrix device comprising an active region and an ESD protection circuit. The active region comprises a plurality of scan lines and a plurality of data lines. The ESD protection circuit comprises a first power line, a second power line, at least one first transistor device and at least one second transistor device. A first voltage V1 is applied to the first power line, and a second voltage V2 is applied to the second power line, wherein the first voltage V1 is not equal to the second voltage V2. The first transistor device comprises a first gate, a first drain and a first source, wherein the first gate and the first drain are electrically connected to the scan line or the data line, and the first source is electrically connected to the first power line. The second transistor device comprises a second gate, a second drain and a second source, wherein the second gate and the second drain are electrically connected to the second power line, and the second source is electrically connected to the scan line or the data line.

According to an embodiment of the present invention, a positive voltage is applied to the first power line, and a negative voltage is applied to the second power line.

According to another preferred embodiment of the present invention, the active matrix device further comprises at least one third transistor device. The third transistor device comprises a third gate, a third drain and a third source. The third gate and the third drain are electrically connected to the first power line, and the third source is electrically connected to the second power line.

According to another preferred embodiment of the present invention, the first power line comprises a ring type wire, and the first source of the first transistor device is electrically connected to the ring type wire.

According to another preferred embodiment of the present invention, the first power line comprises a plurality of discrete wires, wherein the first voltage V1 is applied to each of the discrete wires, and a portion of the first sources of the first transistor devices are electrically connected to one of the discrete wires.

According to another preferred embodiment of the present invention, the second power line comprises a ring type wire, and the second gate and the second drain of the second transistor device are electrically connected to the ring type wire.

According to another preferred embodiment of the present invention, the second power line comprises a plurality of discrete wires, wherein the second voltage V2 is applied to each of the discrete wire, and a portion of the second gates and the second drains of the second transistor devices are electrically connected to one of the discrete wires.

According to another preferred embodiment of the present invention, a third voltage V3 is applied to the scan lines, and a fourth voltage V4 is applied to the data lines, wherein V1≧V4>V3≧V2.

The present invention utilizes the arrangement in which the first diodes are connected between the scan lines/data lines and the first power line; and the second diodes are connected between the second power line and the scan lines/data lines, thereby protecting the devices and circuits of the active matrix device from being damaged by the ESD zap. Although there is a very small leakage current flowing through the first diode or the second diode when a reverse voltage exists across the first diode or the second diode, the leakage current flowing through the first diode or the second diode is comparatively smaller than the leakage current existing in the conventional ESD protection circuit, thereby decreasing extra power consumption can be decreased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a conventional ESD protection circuit of an active matrix display device;

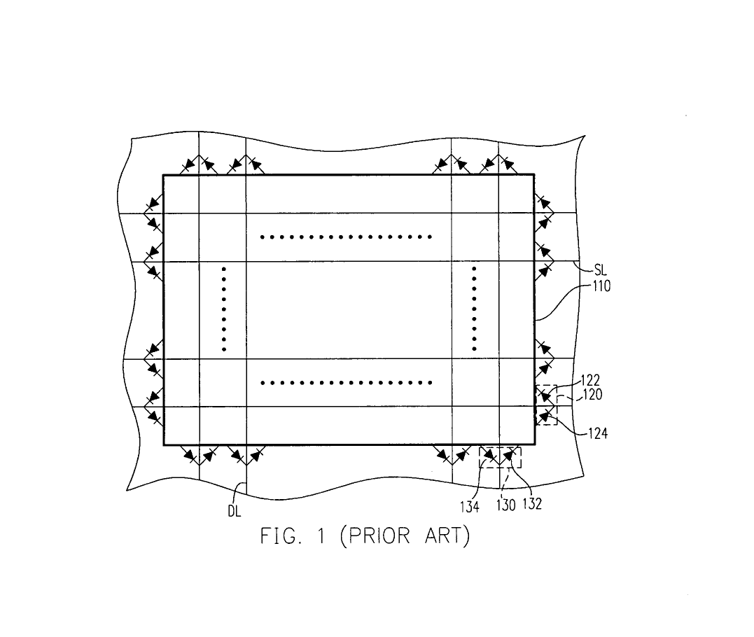

FIG. 2 is a schematic diagram showing an active matrix device having an ESD protection circuit according to a preferred embodiment of the present invention;

FIG. 3 is a schematic diagram showing an active matrix device having an ESD protection circuit according to another preferred embodiment of the present invention;

FIG. 4 is a schematic diagram showing an active matrix device having an ESD protection circuit according to another preferred embodiment of the present invention; and

FIG. 5 is a schematic diagram showing an active matrix device having an ESD protection circuit according to another preferred embodiment of the present invention.

### DESCRIPTION OF THE EMBODIMENTS

Reference will now be made in detail to the present preferred embodiments of the present invention, examples of which are illustrated in the accompanying drawings. Wherever possible, the same reference numbers are used in the drawings and the description to refer to the same or like parts.

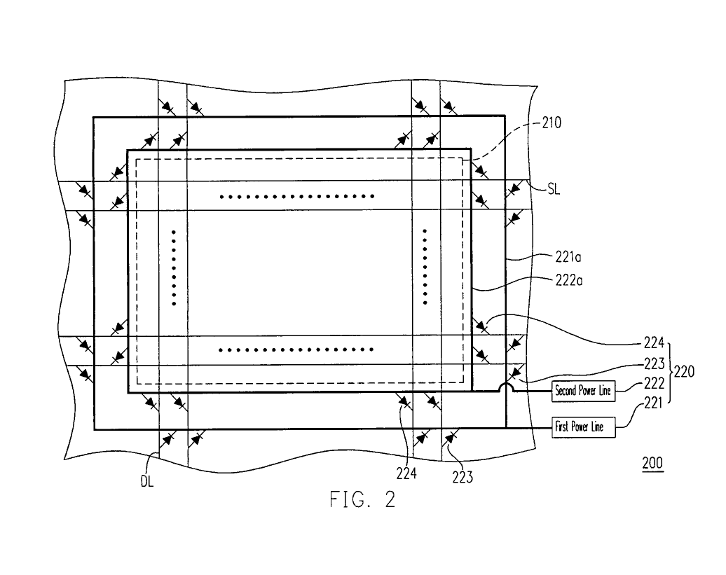

FIG. 2 is a schematic diagram showing an active matrix device having an ESD protection circuit according to a preferred embodiment of the present invention. Referring to FIG. 2, an active matrix device 200 comprises an active region 210 and an ESD protection circuit 220. The active region 210 comprises a plurality of scan lines SL and a plurality of data lines DL. A third voltage V3 and a fourth voltage V4 are the average voltages applied to the scan lines SL and the data lines DL respectively, to control the display status of each pixel. Generally speaking, the third voltage V3 is −15V, and the fourth voltage V4 is 2.5V. The ESD protection circuit 220 comprises a first power line 221, a second power line 222, a plurality of first diodes 223 and a plurality of second diodes 224. In this preferred embodiment of the present invention, the first power line 221 comprises a ring type wire 221a and a first voltage V1 is applied to the first power line 221; and the second power line 222 also comprises a ring type wire 222a and a second voltage V2 is applied to the second power line 222, wherein the first voltage V1 is not equal to the second voltage V2. In one example of the present invention, the first voltage V1 is a positive voltage and the second voltage V2 is a negative voltage. For example, the positive voltage is 10V and the negative voltage is −20V. Each of the first diodes 223 has a positive terminal and a negative terminal. The positive terminals of the first diodes 223 are electrically connected to the scan lines SL or the data lines DL, and the negative terminals of the first diodes 223 are electrically connected to the first power line 221. Similarly, each of the second diodes 224 has a positive terminal and a negative terminal. The positive terminals of the second diodes 224 are electrically connected to the second power line 222, and the negative terminals of the second diodes 224 are electrically connected to the scan lines SL or the data lines DL.

When a positive ESD voltage is applied to the scan line SL suddenly, the ESD current is conducted to the first power line 221 through the first diode 223. Similarly, when a negative ESD voltage is suddenly applied to the scan line SL, the ESD current is conducted to the second power line 222 through the second diode 224. Furthermore, the second power line 222 can be connected to ground voltage. Besides, when a positive ESD voltage is applied to the data line DL, the ESD current is conducted to the first power line 221 through the first diode 223. Similarly, when a negative ESD voltage is applied to the data line DL, the ESD current is conducted to the second power line 222 through the second diode 224. The present invention utilizes the arrangement in which the first diodes 223 are connected between the scan lines SL/data lines DL and the first power line 221; and the second diodes 224 are connected between the second power line 222 and the scan lines SL/data lines DL, for protecting the devices and circuits of the active matrix device 200 from being damaged by the ESD zap. Although there is very small leakage current flowing through the first diode 223 or the second diode 224 when a reverse voltage exists across the first diode 223 or the second diode 224, yet the leakage current flowing through the first diode 223 or the second diode 224 is comparatively smaller than the leakage current occurring in the conventional ESD protection circuit, and thus the extra power consumption can be decreased.

In this embodiment, the ESD protection circuit 220 comprises a plurality of first diodes 223 and a plurality of second diodes 224. However, even if the ESD protection circuit 220 only comprises one first diode 223 and one second diode 224, it still can provide the ESD protection function, so that the number of the first diodes 223 and that of the second diodes 224 are not limited thereto in the present invention.

Besides the ring type wire 221a of the first power line 221 and the type wire 222a of the second power line 222 as shown in FIG. 2, the first power line 221 may comprise a plurality of discrete wires (not shown) to which the first voltage V1 is applied, wherein the negative terminals of the first diodes 223 are electrically connected to one of the discrete wires, and the positive terminals of the first diodes 223 are still electrically connected to the scan lines SL or the data lines DL. Similarly, the second power line 222 may comprise a plurality of discrete wires (not shown) to which the second voltage V2 is applied, wherein the positive terminals of the second diodes 224 are electrically connected to one of the discrete wires, and the negative terminals of the second diodes 224 are still electrically connected to the scan lines SL or data lines DL. Because the discrete wires are electrically connected to the same power line, this design also has the ESD protection function.

In one embodiment of the present invention, different voltages are applied to the scan lines SL, the data lines DL, the first power line 221 and the second power line 222, and satisfy the following formula: V1≧V4>V3≧V2.

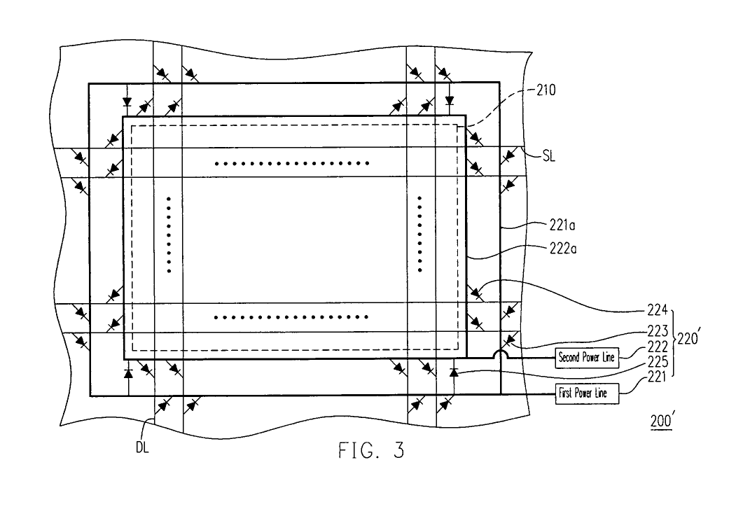

Referring to FIG. 3, FIG. 3 is a schematic diagram showing an active matrix device having an ESD protection circuit according to another preferred embodiment of the present invention. Such as shown in FIG. 3, the active matrix device 200′ is similar to the active matrix device 200 as shown in FIG. 2, but the ESD protection circuit 220′ of the active matrix device 200′ further comprises a plurality of third diodes 225, wherein a positive terminal of each of the third diodes 225 is electrically connected to the first power line 221, and a negative terminal of each of the third diodes 225 is electrically connected to the second power line 222, and there is a bias current flowing through the third diode 225 between the first power line 221 and the second power line 222. Therefore, when a positive ESD voltage is applied to the scan line SL or data line DL suddenly, a portion of the ESD current is conducted to the first power line 221 through the first diodes 223, and the other portion of the ESD current is conducted to the second power line 222 through the third diodes 225, thereby further preventing the devices and circuit of the active matrix device 200′ from being damaged by the ESD zap. Similarly, the number of the third diodes 225 is not limited thereto in the present invention.

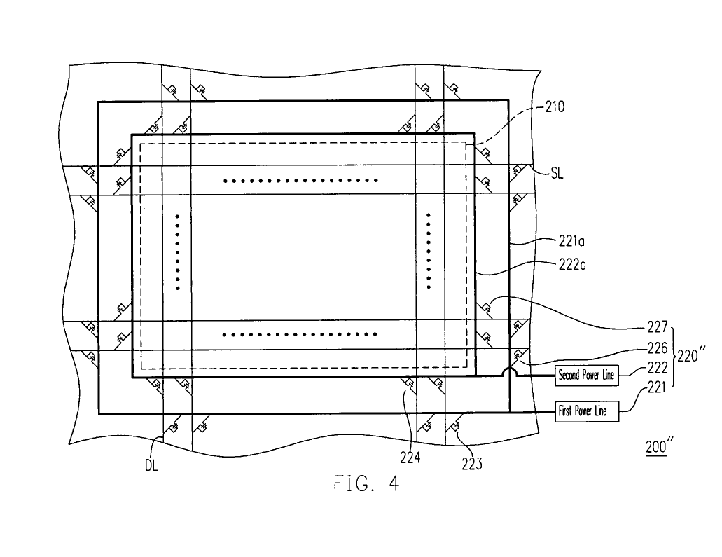

Referring to FIG. 4, FIG. 4 is a schematic diagram showing an active matrix device having an ESD protection circuit according to another preferred embodiment of the present invention. Such as shown in FIG. 4, the active matrix device 200″ is similar to the active matrix device 200 as shown in FIG. 2, wherein the first diodes 223 and the second diodes 224 shown in FIG. 2 are replaced by first transistor devices 226 and second transistor devices 227, respectively. Each of the first transistor devices 226 comprises a first gate, a first drain and a first source. The first gate and the first drain are electrically connected to the scan line SL or the data line DL, and the first source is electrically connected to the first power line 221. The first gate is coupled with the first drain to form a pseudo-diode, such that the first diode 223 shown in FIG. 2 can be replaced by the first transistor device 226. Similarly, each of the second transistor devices 227 comprises a second gate, a second drain and a second source. The second gate and the second drain are electrically connected to the second power line 222, and the second source is electrically connected to the scan line SL or the data line DL. The second gate is coupled with the second drain to form a pseudo-diode, such that the second diode 224 shown in FIG. 2 can be replaced by the second transistor device 227.

When a positive ESD voltage is applied to the scan line SL suddenly, the ESD current is conducted to the first power line 221 through the first transistor device 226. Similarly, when a negative ESD voltage is suddenly applied to the scan line SL, the ESD current is conducted to the second power line 222 through the second transistor device 227. Furthermore, the second power line 222 can be connected to ground voltage. Besides, when a positive ESD voltage is applied to the data line DL, the ESD current is conducted to the first power line 221 through the first transistor device 226. Similarly, when a negative ESD voltage is applied to the data line DL, the ESD current is conducted to the second power line 222 through the second transistor device 227. The present invention utilizes the arrangement in which the first transistor devices 226 are connected between the scan lines SL/data lines DL and the first power line 221; and the second transistor devices 227 are connected between the second power line 222 and the scan lines SL/data lines DL, for protecting the devices and circuits of the active matrix device 200″ from being damaged by the ESD zap. Although there is very small leakage current flowing through the first transistor device 226 or the second transistor device 227 when a reverse voltage exists across the first transistor device 226 or the second transistor device 227, the leakage current flowing through the first transistor device 226 or the second transistor device 227 is comparatively smaller than the leakage current occurring in the conventional ESD protection circuit, and thus the extra power consumption can be decreased.

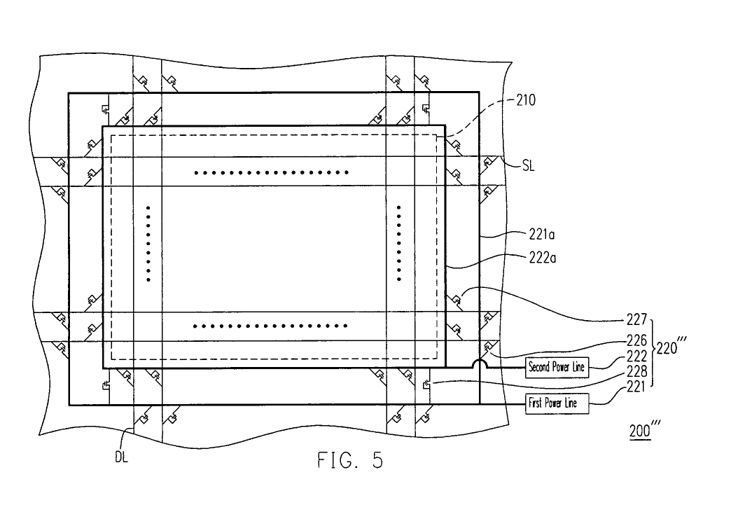

Referring FIG. 5, FIG. 5 is a schematic diagram showing an active matrix device having an ESD protection circuit according to another preferred embodiment of the present invention. Such as shown in FIG. 5, the active matrix device 200′″ is similar to the active matrix device 200″ shown in FIG. 4, but the ESD protection circuit 220′″ of the active matrix device 200′″ further comprises a plurality of third transistor devices 228. Each of the third transistor devices 228 comprises a third gate, a third source and a third drain. The third gate and the third drain of the third transistor device 228 are electrically connected to the first power line 221, and the third source of the third transistor device 228 is electrically connected to the second power line 222, and a bias current flows through the third transistor device 228 between the first power line 221 and the second power line 222. Therefore, when a positive ESD voltage is applied to the scan line SL or data line DL suddenly, a portion of the ESD current is conducted to the first power line 221 through the first transistor devices 226, and the other portion of the ESD current is conducted to the second power line 222 through the third transistor devices 228, so as to further prevent the devices and circuit of the active matrix device 200′″ from being damaged by the ESD zap. Similarly, the number of the third transistor devices 228 is not limited thereto in the present invention.

The above-mentioned active matrix device having the ESD protection function can be a display device, such as a LCD, an OLED display or an E-ink display, or a sensor, such as a photo sensor or an X-ray sensor, but the application of the active matrix device is not limited thereto in the present invention.

In summary, the ESD protection circuit comprises the first power line, the second power line, the first diodes electrically connected between the scan lines/data lines and the first power line, and the second diodes electrically connected between the second power line and the scan lines/data lines. When a positive or negative ESD voltage is applied to the scan lines or the data lines, the ESD current is conducted to the first power line or the second power line through the first diodes or the second diodes, so as to protect the devices and circuits of the active matrix device from being damaged by the ESD zap. Although there is very small leakage current flowing through the first diode or the second diode when a reverse voltage exists across the first diode or the second diode, the leakage current flowing through the first diode or the second diode is comparatively smaller than the leakage current existing in the conventional ESD protection circuit, and thus the extra power consumption can be decreased. Besides, the present invention may utilize the arrangement of the third diodes to share the ESD current applied to the first power line, so as to further prevent the active matrix device from being damaged by the ESD zap. Furthermore, the first diodes, the second diodes and the third diodes of the ESD protection circuit can be replaced by the first transistor devices, the second transistor devices and the third transistor devices, respectively, for protecting the devices and circuits of the active matrix device from being damaged by the ESD zap.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active matrix device, comprising:
an active region comprising a plurality of scan lines and a plurality of data lines;
an ESD protection circuit, comprising:
a first power line and a second power line, wherein a first voltage (V1) is applied to the first power line, a second voltage (V2) is applied to the second power line, and the first voltage (VI) is not equal to the second voltage (V2);
at least one first diode, wherein a positive terminal of the first diode is electrically connected to the scan line or the data line, and a negative terminal of the first diode is electrically connected to the first power line; and
at least one second diode, wherein a positive terminal of the second diode is electrically connected to the second power line, and a negative terminal of the second diode is electrically connected to the scan line or the data line.

2. The active matrix device according to claim 1, wherein a positive voltage is applied to the first power line, and a negative voltage is applied to the second power line.

3. The active matrix device according to claim 1, further comprising at least one third diode, wherein a positive terminal of the third diode is electrically connected to the first power line, and a negative terminal of the third diode is electrically connected to the second power line, and a bias current flows through the third diode between the first power line and the second power line.

4. The active matrix device according to claim 1, wherein the first power line comprises a ring type wire, and the negative terminal of the first diode is electrically connected to the ring type wire.

5. The active matrix device according to claim 1, wherein the first power line comprises a plurality of discrete wires, and the first voltage (V1) is applied to each of the discrete wires, and a portion of the negative terminals of the first diodes are electrically connected to one of the discrete wires.

6. The active matrix device according to claim 1, wherein the second power line comprises a ring type wire, and the positive terminal of the second diode is electrically connected to the ring type wire.

7. The active matrix device according to claim 1, wherein the second power line comprises a plurality of discrete wires, the second voltage (V2) is applied to each of the discrete wires, and a portion of the positive terminals of the second diodes are electrically connected to one of the discrete wires.

8. The active matrix device according to claim 1, wherein a third voltage (V3) is applied to the scan lines, and a fourth voltage (V4) is applied to the data lines, wherein V1≧V4>V3≧V2.

9. An active matrix device, comprising:
an active region comprising a plurality of scan lines and a plurality of data lines;
an ESD protection circuit, comprising:
a first power line and a second power line, wherein a first voltage (V1) is applied to the first power line, and a second voltage (V2) is applied to the second power line, and the first voltage (V1) is not equal to the second voltage (V2);
at least one first transistor device comprising a first gate, a first drain and a first source, wherein the first gate and the first drain are electrically connected to the scan line or the data line, and the first source is electrically connected to the first power line; and
at least one second transistor device comprising a second gate, a second drain and a second source, wherein the second gate and the second drain are electrically connected to the second power line, and the second source is electrically connected to the scan line or the data line.

10. The active matrix device according to claim 9, wherein a positive voltage is applied to the first power line, and a negative voltage is applied to the second power line.

11. The active matrix device according to claim 9, further comprising at least one third transistor device, wherein the third transistor device comprises a third gate, a third drain and a third source, and the third gate and the third drain are electrically connected to the first power line, and the third source is electrically connected to the second power line.

12. The active matrix device according to claim 9, wherein the first power line comprises a ring type wire, and the first source of the first transistor device is electrically connected to the ring type wire.

13. The active matrix device according to claim 9, wherein the first power line comprises a plurality of discrete wires, and the first voltage (V1) is applied to each of the discrete wires, and a portion of the first sources of the first transistor devices are electrically connected to one of the discrete wires.

14. The active matrix device according to claim 9, wherein the second power line comprises a ring type wire, and the second gate and the second drain of the second transistor device are electrically connected to the ring type wire.

15. The active matrix device according to claim 9, wherein the second power line comprises a plurality of discrete wires, and the second voltage (V2) is applied to each of the discrete wires, and a portion of the second gates and the second drains of the second transistor devices are electrically connected to one of the discrete wires.

16. The active matrix device according to claim 9, wherein a third voltage (V3) is applied to the scan lines, and a fourth voltage (V4) is applied to the data lines, wherein V1≧V4>V3≧V2.
